(19) United States
(12) Patent Application Publication
(10) Pub. No.: US 2003/0099832 A1
(43) Pub. Date: May 29, 2003

(54) Controlled permeability film and method of making

(75) Inventor: Michael G. Borchardt, Willowbrook, IL (US)

Correspondence Address: THOMAS C. FEIX, ESQ., THE CLOROX COMPANY, P.O. BOX 24305, OAKLAND, CA, 94623-1305, US

(73) Assignee: The Glad Products Company

(21) Appl. No.: 10/304,401

(22) Filed: Nov. 26, 2002

Related U.S. Application Data
(60) Provisional application No. 60/334,005, filed on Nov. 28, 2001.

(51) Int. Cl. B32B 17/02

(52) U.S. Cl. 428/402; 428/304.4

(57) ABSTRACT

A controlled permeability film composition including a film forming polymer; an inert porous filler in an effective amount to reduce the ratio of carbon dioxide permeability to the oxygen permeability of the film; and wherein the filler has a particle size greater than the intrinsic film thickness of the composite film; and a non-porous filler having a particle size larger than that of the inert pour filler and being present in an amount in an effective amount to control excessive variablility of oxygen transmission rate through film upon activation of the film by compression, for example, by roll crushing. Preferably the porous filler is present in an amount sufficient to reduce the ratio of carbon dioxide to oxygen permeability of the controlled permeability film. The addition of the non porous filler provides improved properties, for example, better permeability/temperature behavior, more consistent film properties and better CO.sub.2 /O.sub.2 permeability ratio. The larger non porous particles help control the variability of the OTR of the film by serving as a buffer to reduce the sensitivity to the pressure activation.

### FIELD OF THE INVENTION

The present invention relates to improvements in controlled permeability film compositions for use in controlled atmosphere packaging and to the protective packaging of sensitive produce therewith.

### BACKGROUND OF THE INVENTION

Control of carbon dioxide (CO₂) and oxygen (O₂) concentration around produce has been shown in the prior art to increase the storage life thereof. Conditions for the optimal storage of horticultural commodities are influenced by factors which include crop species, cultivar, growing conditions, maturity, quality, temperature, relative humidity, packaging, and storage duration. Storage under controlled and modified atmosphere is influenced by the concentration of oxygen, carbon dioxide, ethylene, water vapor and other gases. Controlled atmosphere (CA) storage is achieved by externally supplying a gas stream of the required O₂ and CO₂ concentration into the storage cold room. Controlled atmosphere research into broccoli, for example, has shown that oxygen levels below approximately 1% and CO₂ levels higher than approximately 15% independently induce offensive off-odors and off-flavors. Reported optimum O₂ and CO₂ concentrations for broccoli range from approximately 1 to 2.5% and approximately 5 to 10% respectively. Controlled atmosphere packaging achieves extended produce life because of effects such as slowing respiration and inhibiting pathogen growth.

It is also known in the prior art that CO₂ and O₂ atmospheres surrounding produce can be modified by utilizing the respiration behavior of the produce where O₂ is converted to CO₂. With modified atmosphere (MA) packaging, produce is stored in polymeric film where the film permeability is exactly matched to the expected respiration behavior as influenced by temperature and atmosphere changes to provide the optimum CO₂and O₂ atmosphere. The accumulated O₂ and CO₂concentration in such a package will be related to the rate at which O₂ and CO₂ is consumed or generated by the produce and the container permeability by a simple mass balance. The sensitivity of this balance to O₂ and CO₂ permeability and the possibility of producing commodity polymer films require highly consistent and economic manufacturing of controlled permeability films.

In the prior art, methods of controlling film permeability include uniaxially oriented filled films disclosed in European patent application 311 423 A2, addition of mineral oil to polyolefin films disclosed in European patent application 308 106 A2, use of EVA copolymers and very low density polyethylene (Research Disclosure June 1988 p 408). Such films of controlled permeability have been partially successful, however, their success has been limited by specialty equipment needed to produce some of the films, lack of economic raw materials and difficulty in producing consistent film permeabilities. Moreover the commercial application of MA techniques has been limited due to a number of factors including cost and total quality management.

For example, modified atmosphere packaging has not been applied to highly sensitive produce such as broccoli, commercially, because of the risk of offensive odor and flavor. Many workers have attempted modified atmosphere packaging of broccoli and all results reported show CO₂ and O₂ atmospheres lower and higher respectively than the controlled atmosphere optimum range.

U.S. Pat. No. 5,807,630 to Christie et al. discloses controlled permeability film including a film forming polymer and an inert porous filler in an amount effective to reduce the ratio of the carbon dioxide permeability to the oxygen permeability of the film. Christie using an inert porous filler having a particle size that is greater than the intrinsic film thickness to increase the permeability of oxygen through the film. U.S. Pat. No. 5,891,376 to Christie et al. describes a process to modify the permeability of a film containing an inert porous filler having a particle size greater than the intrinsic film thickness. In accordance with a preferred embodiment the permeability of the film is modified by subjecting the film to a pressure treatment (e.g., contacting the film with a pressure plate or roller) with a compressive force sufficient to thin or remove film forming material between the filler particles and the surrounding atmosphere. The filler particles, when crushed, create localized regions of high permeability. Creation of a great number of these highly permeable areas results in an overall increase in the film's oxygen transmission rate (OTR).

Such films containing inert porous filler have been partially successful, however, their success has been limited by the difficulty in producing film material having an OTR within a consistent target range. Stated in another way, the OTR of films made using this technology suffer from excessive variability.

Accordingly, it is an object of the present invention to reduce the OTR variability of controlled permeability films containing inert porous filler of the type described above.

### SUMMARY OF THE INVENTION

In accordance with one embodiment of the present invention there is provided a controlled permeability film composition including

a film forming polymer;

an inert porous filler in an effective amount to reduce the ratio of carbon dioxide permeability to the oxygen permeability of the film; and wherein the filler has a particle size greater than the intrinsic film thickness of the composite film; and

a non-porous having a particle size larger than that of the inert pour filler and being present in an amount in an effective amount to control excessive variablility of oxygen transmission rate through film upon activation of the film by compression.

In accordance with the prior art, a preferred technique for activating the films is by subjecting the film to compressive forces (e.g., applying a crush roll to the film) whereby the thin skin of film covering the portions of the inert porous filler particles material that extend beyond the thickness of the film is thinned and/or broken to allow oxygen transfer through the film via the porous filler particles.

The present invention uses two particle size distributions including the inert porous filler particles of the prior art and larger diameter particles that are not porous, or at least a portion of which are not porous. The larger non porous particle help control the variability of the OTR of the film by serving as a buffer to reduce the sensitivity to the pressure activation step.

Suitable polymeric material for use in the present invention include polyolefins of differing grades. Particularly preferred polyolefins are polyethylenes and oxygenated polyethylenes, polypropylene, polyesters including polyethylene terephthalate and polybutalene terephthalate, vinyl polymers including polyvinyl chloride, polyvinyl acetate, ethylene-vinyl acetate copolymers and ethylene-vinyl alcohol copolymers, polycarbonates and polystyrene, polyalkyleneoxide polymers including polyethylene oxide polymer; and mixtures thereof.

The film may also be formed as a composite film comprising two or more polymers blended together. The most preferred blended films may be selected depending upon the desired characteristics of the film. It is preferred that a composite film comprise 30 to 99% by weight based on the total weight of the composite film of a polyolefin polymer; and approximately 1 to 70% by weight based on the total weight of the composite film of a dispersing polymer selected from polyolefins, polyesters, vinyl polymers, polycarbonates, polystyrenes, polyalkylene olefin polymers and mixtures thereof.

Preferably the porous filler is present in an amount sufficient to reduce the ratio of carbon dioxide to oxygen permeability of the controlled permeability film. The addition of the non porous filler provides improved properties, for example, better permeability/temperature behavior, more consistent film properties and better CO.sub.2/O.sub.2 permeability ratio.

Methods and apparatus which incorporate the features described above and which are effective to function as described above constitute further, specific objects of the invention. Other objects and advantages of the invention will become apparent upon reading the following description and upon reference to the drawings.

### BRIEF DESCRIPTION OF THE DRAWINGS

For a more complete understanding of this invention reference should now be had to the embodiments illustrated in greater detail in the accompanying drawings and described below by ways of examples of the invention. In the drawings:

FIG. 1 represents a schematic of intrinsically thin walled polymer film containing inert porous filler particles in accordance with the prior art.

FIG. 2 represents a schematic of intrinsically thin walled polymer film containing both inert porous filler-particles and non porous filler particles in accordance with the present invention.

### DESCRIPTION OF THE PREFERRED EMBODIMENTS

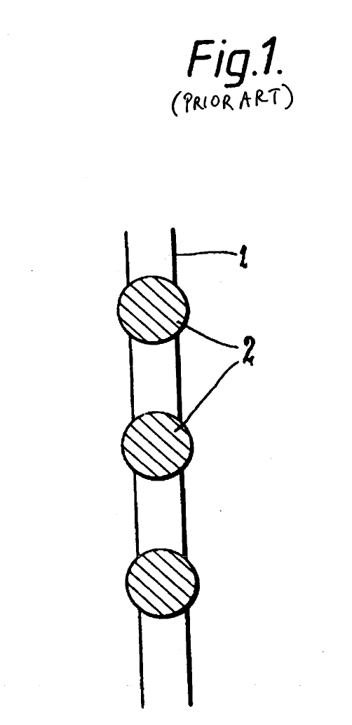

FIG. 1 shows comparative sizes of the polymer film 1 and the porous filler particles 2 which have a particle size greater than the thickness of the film in accordance with the prior art.

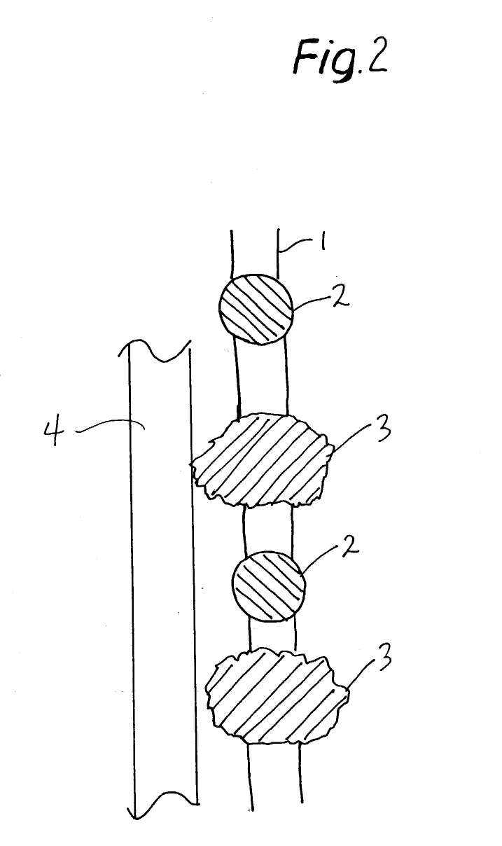

FIG. 2 shows comparative sizes of the polymer film of the present invention which include porous filler particles 2 having a particle size greater that the thickness of the film and non porous filler particles 3 having a particle size greater than that of the porous filler particles 2. Also shown is a crush roll 4 which is used to activate the film by thinning or removing film forming material between the porous filler particles 2 and the surrounding atmosphere. The presence of the larger non porous particles 3 act as a buffer to the crush roll 4 thereby resulting in e selective activation of the porous particles 2 and hence can be used to reduce the sensitivity of the film to the activation step.

The controlled permeability film utilized in this aspect of the present invention is preferably a polyethylene film, more preferably a low density polyethylene (LDPE) film. The porous filler utilized in this aspect of the present invention may be a pumice filler. The non porous filler utilized in the present invention may be mica.

### EXAMPLE

Three film samples were prepared and then tested for oxygen permeability using the ASTM D 3985-81 standard method. The oxygen concentration of the test method was 1%. The results were not normalized to thickness. The Sample 1 film was the control sample and contained no filler material. The Sample 2 film contained only an inert porous filler. The Sample 3 film contained both the inert porous filler of Sample 2 and a non-porous filler.

The film nominally contained 70% 0.925 density 3.5 MI tubular LDPE and 30% 0.938, 3.3 MI Unipol LLDPE and was extruded through a 35″ slot die using a conventional cast process. The inert porous filler was incorporated into the LDPE/LLDPE blend mixing a master batch containing 10% of the filler, at a 1% level, resulting in a final concentration of inert porous filler of 1000 ppm. The non-porous filler was added through a master batch containing 25% of the filler, and let down at the 1% level, resulting in a final concentration of 2500 ppm. All the blends were created by dry blending and tumbling the mixture.

All the films were cast extruded at 200 ft/min through a die at 218° C. (425° F.) and at the settings that would result in a gauge of 44.5 (1.75 mils) microns had the particles not been present. Samples 2 and 3 were crush roll activated at room temperature and at a pressure of 12.7 kg. The average OTR for the three samples above are listed in TABLE 1 below.

TABLE A

| | Film Sample 1 | Film Sample 2 | Film Sample 3 |
|---|---|---|---|
| Inert Porous Filler | 0 | 1000 | 1000 |
| Concentration ppm | | | |
| Non-Porous Filler | 0 | 0 | 2500 |
| Concentration ppm | | | |
| OTR (cc/100 in²-Day) | 230 | 20,000 | 6000 |

It is believed that the mica (non-porous filler) acts as a buffer to the crushing of the porous filler and will have the benefit of reducing the variability of the OTR of films made at the same conditions. It is also believed that any non-porous filler that is larger than the porous filler will serve this function. It is further believed that adding any non-porous filler as a fraction of the total filler package will act as a buffer and help control the variability of the film OTR.

From the foregoing it will be understood that modifications and variations may be effectuated to the disclosed structures—particularly in light of the foregoing teachings—without departing from the scope or spirit of the present invention. As such, no limitation with respect to the specific embodiments described and illustrated herein is intended or should be inferred. On the contrary, it is intended to cover all alternatives, modifications and equivalents as may be included within the spirit and scope of the invention as defined by the appended claims.

What is claimed is:

1. In a controlled permeability film including a film forming polymer and an inert porous filler in an amount in the range of from 0.005 to 2% by weight of the total film, the amount of inert porous filler being effective to reduce the ratio of the carbon dioxide permeability to the oxygen permeability of the film compared with a film without the inert porous filler; and wherein the inert porous filler has a particle size greater than the intrinsic film thickness of the film forming polymer, wherein the improvement comprises:
a non-porous filler having a particle size larger than the particle size of said inert porous filler and being present in said film forming polymer in an amount effective to buffer against excessive activation of the inert porous filler upon being subjected to a compressive force.
